(19) United States
(12) Patent Application Publication
(10) Pub. No.: US 2009/0278743 A1
(43) Pub. Date: Nov. 12, 2009

(54) BEAM FORMING SYSTEM AND METHOD FOR BEAM FORMING

(75) Inventor: Seong-ho WEE, Goyang-si (KR)

Correspondence Address: H.C. PARK & ASSOCIATES, PLC, 8500 LEESBURG PIKE, SUITE 7500, VIENNA, VA, 22182, US

(73) Assignee: PANTECH&CURITEL COMMUNICATIONS, INC., Seoul (KR)

(21) Appl. No.: 12/405,687

(22) Filed: Mar. 17, 2009

(30) Foreign Application Priority Data
May 6, 2008 (KR) 10-2008-0041772

(51) Int. Cl. H01Q 3/00

(52) U.S. Cl. 342/377

(57) ABSTRACT

A beam forming method of a radio network controller includes receiving information related to beam forming, calculating a distance between the mobile terminal and a base station and velocity of the mobile terminal based on the information related to beam forming, determining whether to perform beam forming, and allocating second scrambling codes (SSCs) to sectors of a base station cell while performing beam forming. One SSC is allocated to only the sector in which the mobile terminal is located. A beam forming system to perform the method includes an information receiving unit to receive information related to beam forming, a position calculation unit to determine distance to and velocity of the mobile terminal, a beam forming determining unit, and a beam forming processing unit to allocate the SSCs to sectors while performing the beam forming.

### CROSS REFERENCE TO RELATED APPLICATION

This application claims priority from and the benefit of Korean Patent Application No. 10-2008-0041772, filed on May 6, 2008, which is hereby incorporated by reference for all purposes as if fully set forth herein.

### BACKGROUND OF THE INVENTION

1. Field of the Invention

The present invention relates to a beam forming system and method for beam forming, and more particularly, to a beam forming system and a method for beam forming that may reduce interference while beam forming.

2. Discussion of the Background

A beam forming technique refers to a “smart” antenna technique that improves signal quality by dividing a base station cell into several sectors, concentrating radio waves toward a subscriber's direction, and reducing interference signals from other subscribers.

For example, if cell of a wideband code division multiple access (W-CDMA) base station is divided into three sectors, each sector may be a fan-shaped sector of 120 degrees, and the base station can concentrate the radio waves toward the sector where a target user equipment (UE), or mobile terminal, is located such that the signal quality at the UE can be improved.

### SUMMARY OF THE INVENTION

This invention provides a beam forming system that may reduce interference while beam forming.

This invention also provides a method for beam forming that may reduce interference while beam forming.

Additional features of the invention will be set forth in the description which follows, and in part will be apparent from the description, or may be learned by practice of the invention.

This invention discloses a beam forming system, including an information receiving unit to receive information related to beam forming, a position calculation unit to calculate mobile terminal information based on the information related to beam forming, the mobile terminal information including a velocity of a mobile terminal and a distance between the mobile terminal and a base station, a beam forming determining unit to determine whether to perform beam forming, and a beam forming processing unit to divide a cell of the base station into a plurality of sectors, and to allocate second scrambling codes (SSCs) to the sectors while performing beam forming. Further, one SSC is allocated only to a sector in which the mobile terminal is located.

This invention discloses a method for beam forming, including receiving information related to beam forming; calculating mobile terminal information based on the information related to beam forming, the mobile terminal information including a velocity of a mobile terminal, and a distance between the mobile terminal and a base station; determining whether to perform beam forming, dividing a cell of the base station into a plurality of sectors, and allocating second scrambling codes (SSCs) to the sectors while performing beam forming. Further, one SSC is allocated only to a sector in which the mobile terminal is located.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic view of a wideband code division multiple access (W-CDMA) system.

FIG. 2 shows a block diagram of a beam forming system according to an exemplary embodiment of the present invention.

FIG. 3 illustrates a cell of a base station divided into sectors.

FIG. 4 shows the absolute radio frequency channel number (ARFCN) defined by a global system for mobile communications (GSM) scheme.

FIG. 5 is a flowchart illustrating a method for beam forming according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

If an element is referred to as being “connected to” another element, it can be directly connected to the other element or intervening elements may be present. In contrast, an element referred to as being “directly connected to” another element would have no intervening elements.

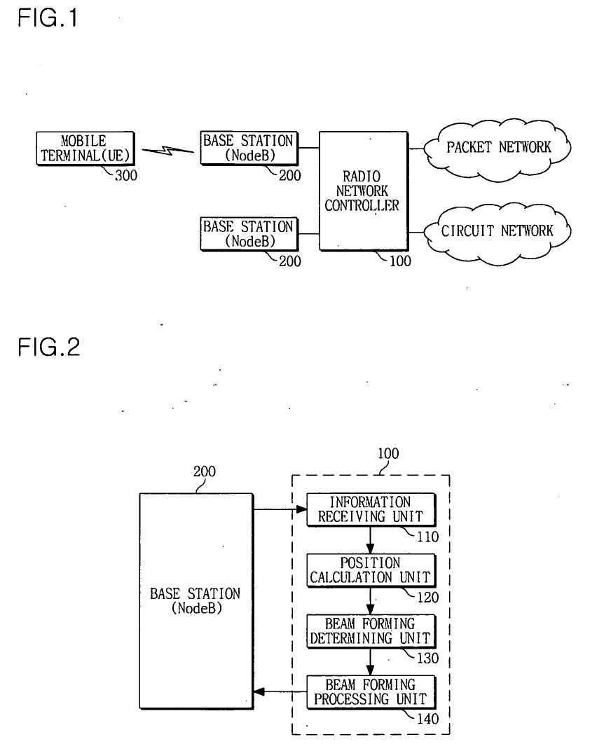

FIG. 1 is a schematic view of a wideband code division multiple access (W-CDMA) system.

Referring to FIG. 1, a radio network controller (RNC) 100 is connected to one or more base stations 200. The RNC 100 processes a control signal transmitted from a base station 200, controls access and handoff of a mobile terminal 300, and operates with a circuit network for circuit switching service and with a packet network for data service.

FIG. 2 is a block diagram of a beam forming system according to an exemplary embodiment of the present invention.

As shown in FIG. 2, the beam forming system may be implemented in the RNC 100. More specifically, the beam forming system may be implemented as software, hardware, or a combination thereof. The beam forming system includes an information receiving unit 110, a position calculation unit 120, a beam forming determining unit 130, and a beam forming processing unit 140.

The information receiving unit 110 receives information related to beam forming from the base station 200. The information related to beam forming may have been received by the base station 200 from the mobile terminal 300, and then transmitted from the base station 200 to the information receiving unit 110.

If the RNC 100 determines to perform the beam forming, the mobile terminal 300, having a call established between itself and the base station 200, transmits information about beam forming to the connected base station 200 to concentrate radio waves radiated from the base station 200 to a domain or sector in which the mobile terminal 300 is located.

For example, the information about beam forming may be position information of the mobile terminal 300 obtained by a global positioning system (GPS) transceiver provided in or connected, by wires or wirelessly, to the mobile terminal 300.

The position calculation unit 120 uses the information about beam forming received by the information receiving unit 110 to calculate a distance between the mobile terminal 300 and the base station 200, and a moving speed and moving direction of the mobile terminal 300.

Specifically, if at least two sets of position information of a mobile terminal 300 are received, the distance between the mobile terminal 300 and a corresponding base station 200, and the velocity, including moving speed and moving direction, of the mobile terminal 300 can be calculated by comparing the sets of position information.

The beam forming determining unit 130 determines whether to perform beam forming according to the calculation result of the position calculation unit 120.

The WCDMA system operates a cell of a base station 200 as a single unit in a cell where there are a smaller number of users of mobile terminals 300, but if the number of mobile terminals 300 increases or is consistently great in a cell, the WCDMA system may divide the cell of the base station 200 into more than one sector using a beam forming technology under the control of the RNC 100. The WCDMA system then generates a directional antenna beam pattern to transmit radio waves.

If the position calculation unit 120 obtains the position of the mobile terminal 300 by calculating the distance between the mobile terminal 300 and the base station 200, and also calculates the moving speed and moving direction of the mobile terminal 300, the beam forming determining unit 130 determines whether to perform beam forming. For example, the beam forming determining unit 130 may perform the beam forming if the number of mobile terminals 300 located in a given base station cell is greater than a predetermined value.

If the beam forming determining unit 130 determines to perform the beam forming, the beam forming processing unit 140 divides a cell of the base station into more than one sector, and allocates different second scrambling codes (SSC) to the sectors while performing beam forming. The allocation of SSCs may be made according to the number of mobile terminals 300 in each sector.

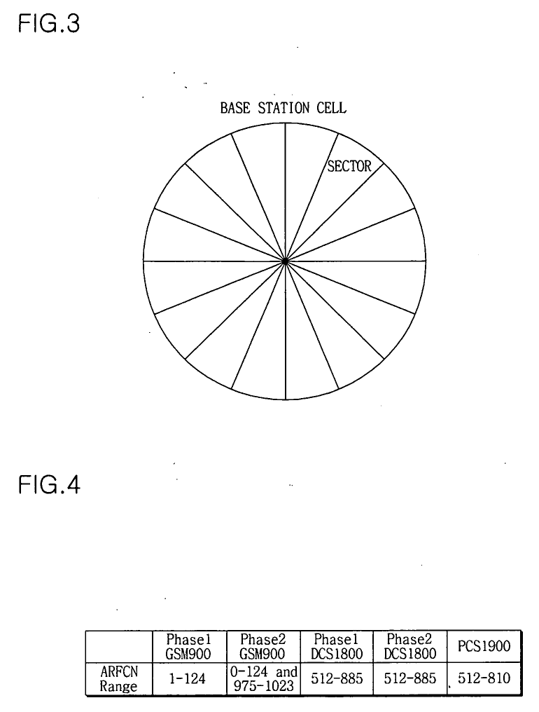

If the beam forming determining unit 130 determines to perform the beam forming, the beam forming processing unit 140 may divide the cell of the base station into several sectors by angles as shown in FIG. 3, and then concentrates radio waves on a sector where the corresponding mobile terminal 300 is located so that interference signals of other mobile terminals 300 can be reduced. The beam forming system may thereby improve wireless signal quality. FIG. 3 illustrates a cell of a base station divided into sectors.

Different SSCs may be allocated to sectors according to the existence of the corresponding mobile terminal 300, and consequently the sectors can process signals individually. Hence, the throughput of data can be increased and a more efficient management of mobile terminals 300, that is, subscribers is possible.

The W-CDMA system processes signals using SSCs as spread codes to reduce the risk of wiretapping. Each cell can generally accommodate one primary scrambling code (PSC) and fifteen SSCs.

The PSC is generally used to convert a transmitted signal and SSCs are not usually used except for the special purposes. But as described here, SSC is allocated to data to be downlinked or uplinked in each sector so that signals can be processed separately by mobile terminals 300 in each sector.

According to an exemplary embodiment, the beam forming processing unit 140 may allocate an SSC to a channel range different from a channel range to which PSC is allocated when allocating different SSCs to each sector. For example, the channel range may be an absolute radio frequency channel number (ARFCN) defined by GSM, as shown in FIG. 4. FIG. 4 shows the ARFCN defined by the GSM scheme.

If the PSC and SSCs are allocated to the same channel range, more interference may occur than if the PSC and SSCs are allocated to different channel ranges. Therefore, different SSCs allocated to individual sectors may be allocated to a channel range that is different from the channel range to which PSC is allocated. This allocation scheme may help to reduce the interference.

According to an exemplary embodiment, the beam forming processing unit 140 may be implemented to perform beam forming with respect to a dedicated physical channel (DPCH).

In the W-CDMA system, a transmission channel is selected appropriately for packet data to be transmitted based on the characteristic and length of the packet data, and the packet data is transmitted through the selected transmission channel (packet scheduling). A dedicated physical channel (DPCH) of transmission channels is dynamically adapted to radio environment changes by supporting closed loop power control and handoff. Thus, the DPCH may be advantageous for beam forming to improve wireless signal quality by concentrating radio waves on a domain where the mobile terminal 300 is located through the DPCH.

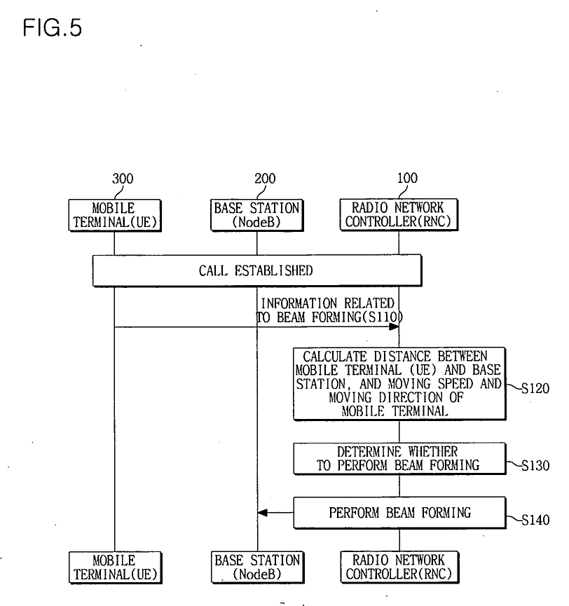

FIG. 5 is a flowchart illustrating a method for beam forming according to an exemplary embodiment of the present invention.

While a call is being established, a mobile terminal 300 transmits information about beam forming to a base station 200, and an RNC 100 receives the information about beam forming from the base station 200 (operation S110).

After receiving the information about beam forming in operation S110, the RNC 100 calculates the distance between the mobile terminal 300 and the base station 200, and also the moving speed and moving direction of the mobile terminal 300 based on the received information about beam forming (operation S120).

Since a method of calculating this mobile terminal information, including the distance between the mobile terminal 300 and the base station 200 and the moving speed and moving direction of the mobile terminal 300, has been already described above, the detailed description will not be repeated.

Then, the RNC 100 determines whether to perform beam forming according to the calculation result obtained in operation S120 (operation S130). Since a method of determining whether to perform beam forming has been already described above, the detailed description will not be repeated.

If the beam forming is to be performed, the RNC 100 divides a cell of the base station into multiple sectors by angle to perform beam forming, and allocates different SSCs to individual sectors (operation S140).

Therefore, different SSCs are allocated to sectors based on whether a corresponding mobile terminal 300 is located in a sector so that each sector can process a signal individually, and thus throughput of data to be processed within a predetermined period of time may increase, providing a more efficient management of data transfer with mobile terminals.

Moreover, in operation S140, the SSCs may be allocated to a channel range different from the channel range to which the PSC is allocated so that interference can be reduced, which may occur if the SSCs and PSC are allocated to the same channel range. Accordingly, more advanced wireless quality can be obtained.

A beam forming system and a method for beam forming according to these described exemplary embodiments can be applicable to a base station of a mobile communications system, mobile terminal management, beam forming techniques, and applications of such techniques.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A beam forming system, comprising:
an information receiving unit to receive information related to beam forming;
a position calculation unit to calculate mobile terminal information based on the information related to beam forming, the mobile terminal information comprising a velocity of a mobile terminal and a distance between the mobile terminal and a base station;
a beam forming determining unit to determine whether to perform beam forming; and
a beam forming processing unit to divide a cell of the base station into a plurality of sectors, and to allocate second scrambling codes (SSCs) to the sectors while performing beam forming,
wherein one SSC is allocated only to a sector in which the mobile terminal is located.

2. The beam forming system of claim 1, wherein the beam forming processing unit allocates the SSCs to a first channel range that is different from a second channel range to which a primary scrambling code (PSC) is allocated.

3. The beam forming system of claim 1, wherein the beam forming processing unit performs beam forming with respect to a dedicated physical channel (DPCH).

4. The beam forming system of claim 1, wherein the information receiving unit receives the information related to beam forming from the mobile terminal via the base station.

5. The beam forming system of claim 1, wherein the velocity of the mobile terminal comprises a moving speed and moving direction of the mobile terminal.

6. The beam forming system of claim 1, wherein the position calculation unit determines the velocity of the mobile terminal by comparing at least two sets of position data included in the information related to beam forming.

7. The beam forming system of claim 1, wherein the beam forming system is arranged in a radio network controller connected to the base station.

8. A method for beam forming, comprising:
receiving information related to beam forming;
calculating mobile terminal information based on the information related to beam forming, the mobile terminal information comprising a velocity of a mobile terminal, and a distance between the mobile terminal and a base station;
determining whether to perform beam forming;
dividing a cell of the base station into a plurality of sectors; and
allocating second scrambling codes (SSCs) to the sectors while performing beam forming,
wherein one SSC is allocated only to a sector in which the mobile terminal is located.

9. The method of claim 8, wherein the SSCs are allocated to a first channel range that is different from a second channel range to which a primary scrambling code (PSC) is allocated.

10. The method of claim 8, wherein information related to beam forming is received from the mobile terminal via the base station.

11. The method of claim 8, wherein the velocity of the mobile terminal comprises a moving speed and moving direction of the mobile terminal.

12. The method of claim 8, wherein the velocity of the mobile terminal is determined by comparing at least two sets of position data received in the information related to beam forming.

13. The method of claim 8, wherein the method is performed by a beam forming system arranged in a radio network controller connected to the base station.
